(19) United States
(12) Patent Application Publication
(10) Pub. No.: US 2020/0079110 A1
(43) Pub. Date: Mar. 12, 2020

(54) IMAGE FORMING APPARATUS AND IMAGE FORMING APPARATUS BODY

(71) Applicants: Munekazu HIRATA, Tokyo (JP); Kunihiko NISHIOKA, Kanagawa (JP); Yohei OSANAI, Kanagawa (JP); Satoshi NARAI, Kanagawa (JP); Tomoya FUJII, Kanagawa (JP); Masatoshi ISHIDA, Kanagawa (JP); Takayuki ANDOH, Kanagawa (JP); Masashi OTA, Kanagawa (JP)

(72) Inventors: Munekazu HIRATA, Tokyo (JP); Kunihiko NISHIOKA, Kanagawa (JP); Yohei OSANAI, Kanagawa (JP); Satoshi NARAI, Kanagawa (JP); Tomoya FUJII, Kanagawa (JP); Masatoshi ISHIDA, Kanagawa (JP); Takayuki ANDOH, Kanagawa (JP); Masashi OTA, Kanagawa (JP)

(73) Assignee: Ricoh Company, Ltd., Tokyo (JP)

(21) Appl. No.: 16/459,904

(22) Filed: Jul. 2, 2019

(30) Foreign Application Priority Data
Sep. 10, 2018 (JP) 2018-169132

(51) Int. Cl. B41J 3/36

(52) U.S. Cl. CPC B41J 3/36

(57) ABSTRACT

An image forming apparatus includes a body including a recording face to be disposed opposite a recording medium, a recording device supported by the body and configured to record an image on the recording medium, a rotator including a rotation shaft and configured to contact and rotate on the recording medium, and a rotator holder configured to hold the rotator. The rotator holder includes a tilt restriction portion and a normal direction pressed portion being a different component from the tilt restriction portion. The tilt restriction portion is to restrict a tilt of the rotation shaft of the rotator around a virtual axis orthogonal to the recording face. The normal direction pressed portion is to receive force in a direction normal to the recording face, exerted from the rotator, the normal direction pressed portion being a different component from the tilt restriction portion.

### CROSS-REFERENCE TO RELATED APPLICATION

This patent application is based on and claims priority pursuant to 35 U.S.C. § 119(a) to Japanese Patent Application No. 2018-169132, filed on Sep. 10, 2018, in the Japan Patent Office, the entire disclosure of which is hereby incorporated by reference herein.

### BACKGROUND

### Technical Field

The present disclosure generally relates to a mobile image forming apparatus and a mobile image forming apparatus body.

### Description of the Related Art

There are mobile image forming apparatuses including a recording device to record an image on a recording medium, a recording device holder to hold the recording device, and a rotator to rotate on the recording medium.

Generally, the recording device is disposed at the bottom of the mobile image forming apparatus, and the mobile image forming apparatus is manually moved by user on the recording medium.

### SUMMARY

According to an embodiment of this disclosure provides an image forming apparatus that includes a body including a recording face to be disposed opposite a recording medium, a recording device supported by the body and configured to record an image on the recording medium, a rotator including a rotation shaft and configured to contact the recording medium and rotate thereon, and a rotator holder configured to hold the rotator. The rotator holder includes a tilt restriction portion and a normal direction pressed portion being a different component from the tilt restriction portion. The tilt restriction portion is to restrict a tilt of the rotation shaft of the rotator around a virtual axis orthogonal to the recording face. The normal direction pressed portion is to receive force in a direction normal to the recording face, exerted from the rotator, the normal direction pressed portion being a different component from the tilt restriction portion.

Another embodiment provides an image forming apparatus body to which a recording device configured to record an image on the recording medium is removably attached. The body includes a recording face to be disposed opposite a recording medium, a rotator including a rotation shaft, and a rotator holder configured to hold the rotator. The rotator is configured to contact the recording medium and rotate on the recording medium. The rotator holder includes a tilt restriction portion and a normal direction pressed portion being a different component from the tilt restriction portion. The tilt restriction portion is to restrict a tilt of the rotation shaft of the rotator around a virtual axis orthogonal to the recording face. The normal direction pressed portion is to receive force in a direction normal to the recording face, exerted from the rotator, the normal direction pressed portion being a different component from the tilt restriction portion.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an enlarged view of an end portion on a rear side of a bottom of a handheld printer according to an embodiment;

FIG. 2 is a perspective view illustrating an exterior of the handheld printer as viewed from above a rear left side of the handheld printer;

FIG. 3 is a perspective view illustrating the exterior of the handheld printer as viewed obliquely from below;

FIG. 4 is a bottom view of the handheld printer;

FIG. 5 is a schematic cross-sectional view of the handheld printer as viewed from the left side;

FIG. 6 is an illustration indicating a positional relationship between a hand of a user and the handheld printer being operated by the user;

FIG. 7 is a perspective view illustrating how the handheld printer forms an image on a recording medium;

FIG. 8 is a block diagram illustrating a part of an electric circuit of the handheld printer, according to an embodiment;

FIGS. 9A and 9B are top views illustrating a relationship between a mounting state of roller assemblies in the handheld printer and the direction of movement of the handheld printer;

FIG. 10 is an exterior perspective view of the handheld printer as viewed from the lower right on the rear side;

FIG. 11 is an enlarged view of an end portion on the rear side of the handheld printer illustrated in FIG. 10;

FIG. 12 is an enlarged view of an end portion on the front side of the handheld printer illustrated in FIG. 10;

FIG. 13 is an exterior perspective view of the handheld printer as viewed from the lower left of the front side;

FIG. 14 is an enlarged view of the end portion on the front side of the handheld printer illustrated in FIG. 13;

FIG. 15 is an exterior perspective view of the handheld printer, together with the roller assemblies and second roller holders in a state removed from the handheld printer, as viewed from the rear right side of the bottom;

FIG. 16 is an exterior perspective view of the handheld printer, together with the roller assemblies and second roller holders in a state removed from the handheld printer, as viewed from the front left side of the bottom;

FIGS. 17A and 17B are perspective views of a front-side second roller holder of the second roller holder illustrated in FIG. 16;

FIGS. 18A and 18B are perspective views of a rear-side second roller holder of the second roller holder illustrated in FIG. 16;

FIG. 19 is a cross-sectional view illustrating mounting of the roller assembly to the housing;

FIGS. 20A and 20B are schematic views illustrating a positional relationship between a printed portion and rollers on a recording medium, and

FIG. 21 is a schematic view illustrating a roller in which a coating is provided on a surface thereof, according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, an image forming apparatus according to an embodiment of this disclosure is described. As used herein, the singular forms “a”, “an”, and “the” are intended to include the plural forms as well, unless the context clearly indicates otherwise.

[Descriptions are given below of a handheld mobile inkjet printer (hereinafter simply referred to as “handheld printer”) that is a mobile image forming apparatus, according to an embodiment of the present disclosure. First, a basic configuration of the handheld printer according to the present embodiment is described.

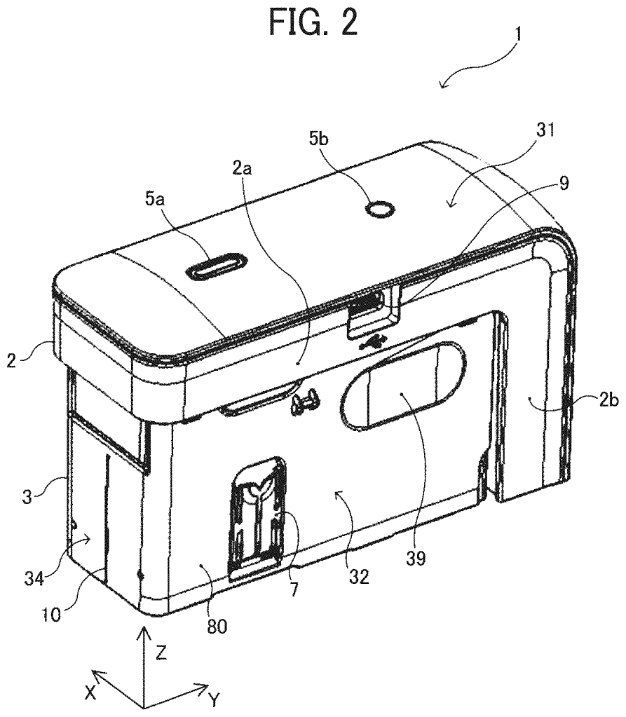

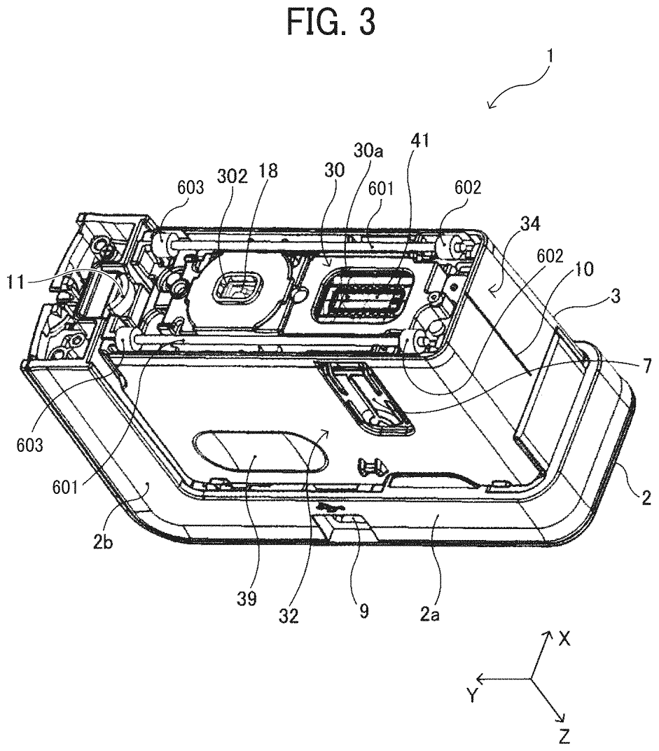

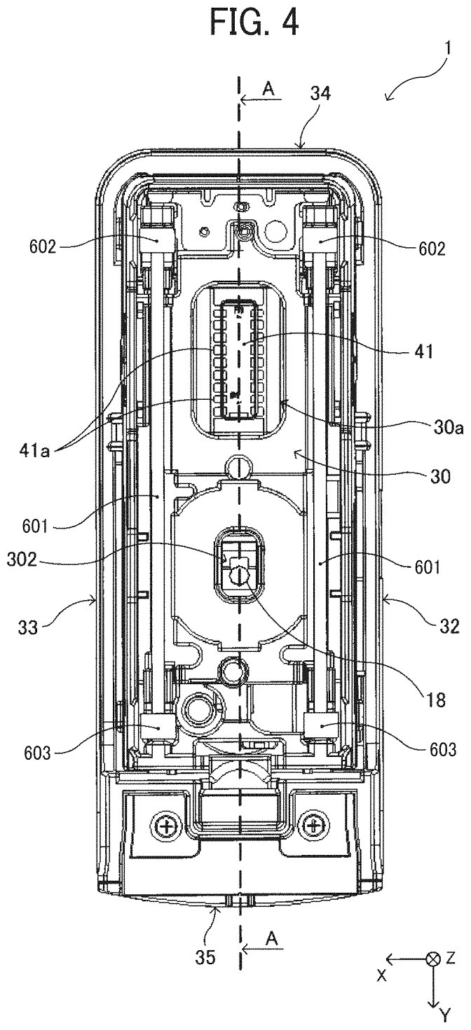

FIG. 2 is a perspective view illustrating an exterior of a handheld printer 1 according to the present embodiment, as viewed from above a rear left side of the handheld printer 1. FIG. 3 is a perspective view illustrating the exterior of the handheld printer 1 as viewed from a bottom of the handheld printer 1 obliquely above. FIG. 4 is a bottom view of the handheld printer 1.

As illustrated in FIGS. 2 and 3, the handheld printer 1 includes an upper unit 2 and a lower unit 3. The handheld printer 1 as a whole is shaped like a rectangular parallelepiped. The handheld printer 1 has such a length in a scanning direction (that is, a printing direction or an X axis direction in drawings) that a user can grasp the handheld printer 1 with a palm.

As illustrated in FIGS. 2 and 3, the lateral direction (a short-side direction) of the body of the handheld printer 1 is defined as X axis direction, and a longitudinal direction of the body orthogonal to the horizontal direction is defined as a Y axis direction. In printing operation using the handheld printer 1, to linearly print letters or illustrations, the handheld printer 1 is moved in the X axis direction, which is the scanning direction. Then, the handheld printer 1 is moved in the Y axis direction to perform line feed.

However, the printing operation using the handheld printer 1 is not limited to the above-described operation. For a case where letters, illustrations, etc. are arranged attractively, the handheld printer 1 can be moved for printing in an oblique direction other than the X axis direction or along a curved track. In addition, the handheld printer 1 can be moved in a direction other than the Y axis direction for line feed.

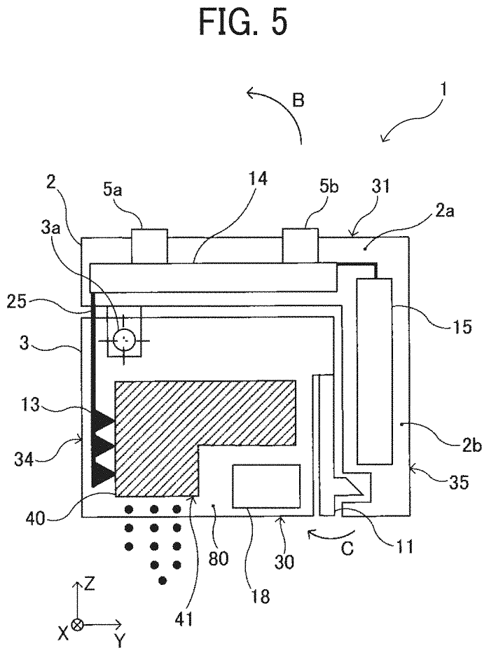

FIG. 5 is a schematic cross-sectional view of the handheld printer 1 as viewed from the left side.

As illustrated in FIG. 5, the upper unit 2 is shaped like a letter “L” and includes a horizontal portion 2a extending in the Y axis direction and a vertical portion 2b extending in the Z-axis direction in the drawings. The vertical portion 2b of the upper unit 2 contains a battery 15 as a power source to supply power to components of the handheld printer 1. The horizontal portion 2a includes a control board 14, and a print button 5a and a power button 5b are connected to the control board 14. The power button 5b is a button for powering on and off the handheld printer 1, and the print button 5a is a button for the timing of ink discharge.

The lower unit 3 includes an upper unit rotation shaft 3a to rotatably support the upper unit 2, a position detection sensor 18 that is an optical sensor for position coordinate detection, a flexible printed circuit (FPC) contact 13, an upper unit lock claw 11, and a housing 80 that supports theses components. The housing 80 of the lower unit 3 contains an ink cartridge 40 (an inkjet head) that includes a recording device 41 (an image forming device) and an ink tank combined into a single unit, and the ink cartridge 40 is removable from the housing 80. The ink cartridge 40 (the inkjet head) is configured to discharge ink from the recording device 41 for image formation. When the handheld printer 1 is used, the recording device 41 to discharge ink droplets are faced down.

As the upper unit 2 is rotated in the direction indicated by arrow B in FIG. 5 with respect to the lower unit 3, an upper opening of the housing 80 of the lower unit 3 is exposed, and the ink cartridge 40 disposed inside the housing 80 can be removable from the housing 80.

In the handheld printer 1 according to the present embodiment, the battery 15 is disposed on the vertical portion 2b of the upper unit 2, and the vertical portion 2b is positioned to cover the front face 35 (on the right in FIG. 5) of the lower unit 3. Thus, the battery 15 is located on the front face 35 side of the ink cartridge 40. Therefore, the height of the handheld printer 1 is reduced compared with the configuration in which the battery 15, which is relatively heavy, is positioned above the ink cartridge 40. Such placement lowers the gravitational center (gravity center position) of the handheld printer 1, thus preventing the handheld printer 1 from falling over while being moved.

In the scanning direction (X axis direction), the size (apparatus width) of the handheld printer 1 is slightly wider than the size of the ink cartridge 40. Minimizing the apparatus width can widen the range in which the handheld printer 1 can be moved in the scanning direction on the surface of the recording medium and maximize a recordable range on the surface of the recording medium.

As illustrated in FIGS. 3 to 5, the handheld printer 1 has a recording face 30 on which the recording device 41 of the ink cartridge 40 is disposed and to be opposed to a recording medium, such as a paper sheet. The handheld printer 1 also has an upper face 31 on the back side of the recording face 30, a left face 32 extending in an orthogonal direction (Y axis direction in the drawing) orthogonal to the scanning direction of the handheld printer 1, and the like. The handheld printer 1 also has, for example, a right face 33 extending in the orthogonal direction (Y axis direction) orthogonal to the scanning direction (X axis direction), a rear face 34 extending in the scanning direction, and a front face 35 extending in the scanning direction. The handheld printer 1 is usually used in such a posture that the recording face 30 is faced vertically down and the upper face 31, which is opposite the recording face 30, is faced vertical up.

The print button 5a and the power button 5b are disposed within an outer edge (within a frame) of the upper face 31. The left face 32 of the upper unit 2 includes a universal serial bus (USB) connection port 9. The USB connection port 9 is a port for connecting a USB cable. The handheld printer 1 is provided with the rechargeable battery 15 mounted therein. The battery 15 can be charged with electric power supplied thereto from an external power supply via the USB cable connected to the USB connection port 9.

As illustrated in FIGS. 2 and 5, the L-shaped upper unit 2 is disposed to cover the upper face 31 and the front face 35 of the lower unit 3, and the upper unit 2 is wider (longer in the X axis direction) than the lower unit 3.

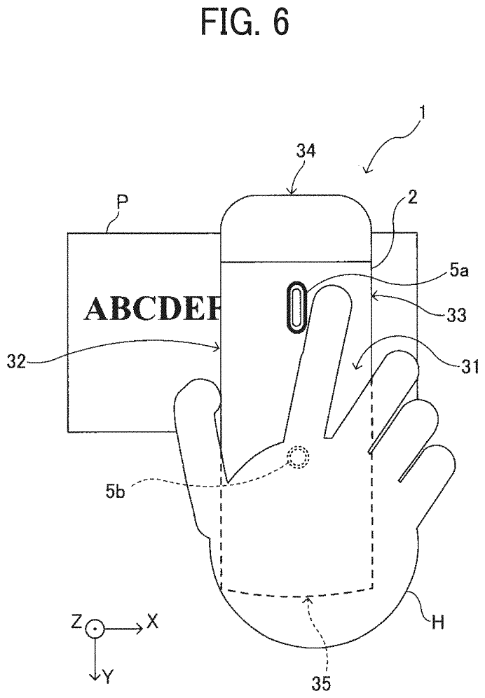

FIG. 6 is an illustration indicating a positional relationship between a hand H of a user and the handheld printer 1 being operated by the user.

As illustrated in FIG. 6, to move the handheld printer 1 for image formation on the recording medium P in the scanning direction (X axis direction, lateral in FIG. 6), the user holds the upper unit 2. Since the upper unit 2 is wider than the lower unit 3, the user can easily hold the upper unit 2 with the hand, and the battery 15 can be contained in the vertical portion 2b. Further, as illustrated in FIG. 2, the left face 32 and the right face 33 of the lower unit 3 respectively include gripped recesses 39 (gripped portions). The gripped recesses 39 are disposed, respectively, at positions where fingers (usually a thumb and a middle finger or a ring finger) of the hand H holding the upper unit 2 when the user uses the handheld printer 1. The user can put his or her fingers in the respective gripped recesses 39 on the left face 32 and the right face 33 with the handheld printer 1 sandwiched between these fingers, thereby holding the handheld printer 1 stably.

The user can hold the power button 5b for a while to switch on and off the power of the handheld printer 1. With the power turned on, the control board 14 mounted in the upper unit 2 of the handheld printer 1 can acquire image information with, e.g., a smartphone, by wireless communication using Bluetooth (registered trademark) communication or the like.

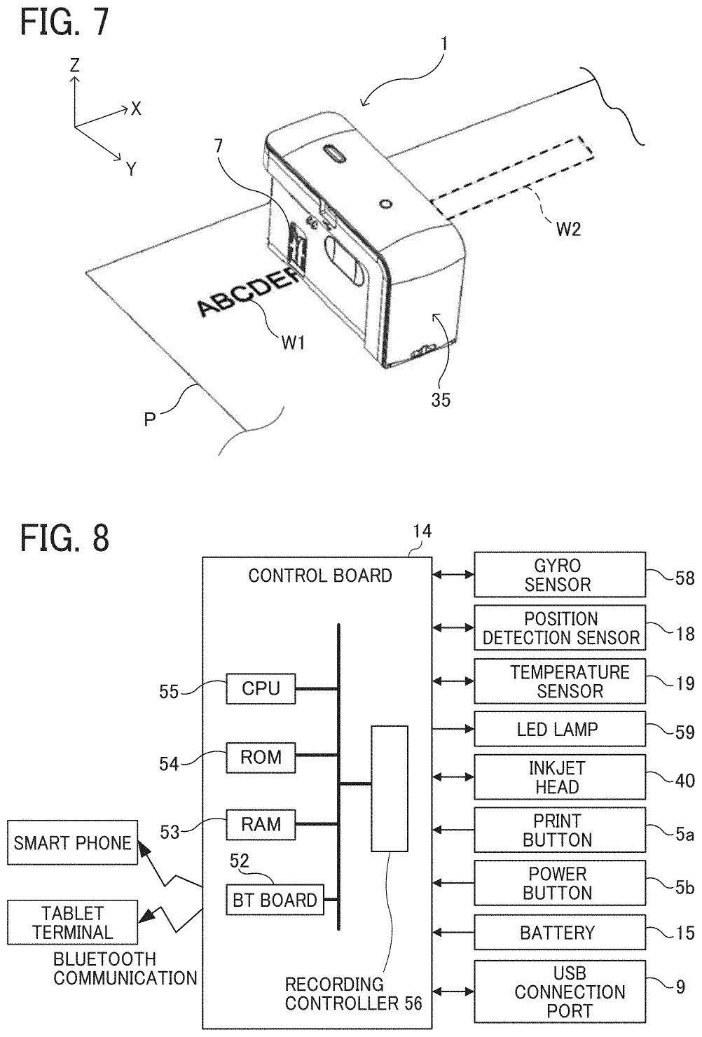

FIG. 7 is a perspective view illustrating how the handheld printer 1 forms an image on the recording medium P.

After the image data is acquired, the handheld printer 1 is placed on the recording sheet P with the recording face 30 opposed to the surface of the recording sheet P. Then, the user presses the print button 5a once and moves the handheld printer 1 in the scanning direction as illustrated in FIG. 7, thus forming an image on the recording medium P. As illustrated in FIG. 7, in the image formation by the handheld printer 1, the user can check an already printed portion W1 and a planned print area W2 in which printing is to be made.

The handheld printer 1 can form an image on the surface of the recording medium P both when the user moves the handheld printer 1 (manual scanning) toward one side (right side in FIG. 7) in the scanning direction (X axis direction and when the user moves the handheld printer 1 to the opposite side (left side in FIG. 7) in the scanning direction. The handheld printer 1 can be configured to discharge ink from the ink cartridge 40 continuously after the user once presses and releases the print button 5a or discharge ink from the ink cartridge 40 only while the user presses the print button 5a.

The recording medium is not limited to paper, such as recording paper, but includes, for example, overhead projector (OHP) sheets, cloth, cardboards, packaging containers, glass, and substrates.

As illustrated in FIGS. 3 and 4, the lower face of the housing 80 serving as the recording face 30 includes a discharge opening 30a. From the discharge opening 30a, the recording device 41 of the ink cartridge 40 mounted in the lower unit 3 is exposed to the outside. The recording device 41 of the ink cartridge 40 includes a plurality of discharge nozzles 41a (e.g., ports) and is capable of discharging ink droplets separately from the respective discharge nozzles 41a as piezoelectric elements are driven.

The width of an image recording area of the recording device 41, that is, the length of the image in the direction (Y axis direction) orthogonal to the scanning direction, is the distance between the discharge nozzles 41a located at both ends of the plurality of discharge nozzles 41a in the Y axis direction.

The ink discharged from the recording device 41 passes through the discharge opening 30a and reaches the recording medium P, thus forming an image thereon.

As a driving source to discharge ink, the ink cartridge 40 can employ, for example, an electromechanical transducer element (a piezoelectric actuator) including a lamination-type piezoelectric element or a thin-film-type piezoelectric element. Example configurations of the driving source further include an electrothermal transducer element, such as a heat element, and an electrostatic actuator including a diaphragm and opposed electrodes.

The ink cartridge 40 has a so-called inkjet mechanism to discharge liquid or droplets such as ink to perform recording. Any inkjet mechanism mountable in handheld printer 1 can be used. In the handheld printer 1 according to the present embodiment, the inkjet mechanism corresponds to the recording device 41 that records an image on a recording medium and is stored in the housing 80 of the lower unit 3.

The “liquid” discharged from the discharge nozzles 41a of the recording device 41 is not particularly limited as long as the liquid has a viscosity and a surface tension that can be discharged from the discharge nozzles 41a. However, it is preferable that the viscosity is 30 mPa·s or less under ordinary temperature and pressure or by heating or cooling. Specifically, the term “ink (liquid)” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, a surface treatment solution, liquid for forming components of electronic elements or light-emitting elements, liquid for forming resist patterns of electronic circuits, or a material solution for three-dimensional fabrication.

Inside the outer edge of the recording face 30, the position detection sensor 18 as a detector is disposed. The position detection sensor 18 contactlessly detects the position of the handheld printer 1 on the recording medium P. The lower face of the housing 80 serving as the recording face 30 is provided with a detection opening 302 to expose a detection portion of the position detection sensor 18.

In the case of a contact type sensor using a rotary encoder or the like, the sensor needs to be in contact with the print surface, and a detection error due to the contact state is likely to occur. Specifically, when the detection portion of the contact type sensor separates from or slips on the print surface, the actual travel distance differs from the travel distance calculated based on the detection result, which is a detection error. On the other hand, the accuracy of detection is higher when the optical sensor as the position detection sensor 18 detects the print surface contactlessly.

The handheld printer 1 further includes two roller assemblies 60 (i.e., left and right roller assemblies) disposed side by side on the recording face 30. Each roller assembly 60 includes a rear side roller 602 and a front side roller 603 disposed inside the outer edge of the recording face 30 and rotatably attached to the housing 80. The rear side roller 602 and the front side roller 603 are secured to a roller shaft 601, and the roller shaft 601 is rotatably held by the housing 80.

When the handheld printer 1 is moved in the scanning direction by the user, the four rollers (the rear side rollers 602 and the front side rollers 603) in contact with the surface of the recording medium P rotate like tires. Owing to such rollers, the user can advance the handheld printer 1 straight in the scanning direction. When the handheld printer 1 is moved straight in the scanning direction, only the four rollers (the rear side rollers 602 and the front side rollers 603) provided on the handheld printer 1 are in contact with the surface of the recording medium P or the surface of the table on which the recording medium P is placed. The recording face 30 is not in contact with the surface of the recording medium P. Therefore, the user can move the handheld printer 1 straight along the scanning direction while keeping a constant distance between the recording device 41 of the ink cartridge 40 and the surface of the recording medium P. Thus, a desired high-quality image can be formed. That is, the four rollers guide the movement of the handheld printer 1 in the scanning direction and assist the linear movement in the scanning direction.

The position detection sensor 18 is a sensor to detect the distance to the surface of the recording medium P, the surface state (for example, asperities) of the recording medium P, and the distance by which the handheld printer 1 has traveled. The position detection sensor 18 is similar to a sensor used for, for example, an optical mouse (a pointing device) of a personal computer. The position detection sensor 18 irradiates, with light, a place (e.g., the recording medium P) where the position detection sensor 18 is placed and reads the state of the place as a “pattern”. The position detection sensor 18 sequentially detects how the “pattern” moves relative to the movement of the position detection sensor 18, to calculate the amount of movement. As the position detection sensor 18, any sensor other than an optical sensor such as an ultrasonic sensor may be used as long as a change in position with respect to the recording medium P can be detected contactlessly. The position detection device of mobile image forming apparatuses, such as handheld printer 1, to which aspects of the present disclosure can be applied is not limited to a contactless sensor such as the position detection sensor 18, but can be a contact-type sensor using a rotary encoder or the like.

FIG. 8 is a block diagram illustrating a portion of an electric circuit of the handheld printer 1.

The control board 14 includes a central processing unit (CPU) 55 that performs various arithmetic processing and program execution, a Bluetooth (registered trademark, hereinafter “BT”) board 52 for short-range wireless communication using Bluetooth, a random access memory (RAM) 53 that temporarily stores data, a read-only memory (ROM) 54, and a recording controller 56. The control board 14 is secured at a position on the back side of the USB connection port 9 in a hollow space of the upper unit 2.

The BT board 52 performs data communication by short-range wireless communication with an external device, such as a smartphone or a tablet terminal. The ROM 54 stores, for example, firmware for hardware control of the handheld printer 1 and drive waveform data of the ink cartridge 40. The recording controller 56 executes data processing for driving the ink cartridge 40 and generates drive waveforms.

The control board 14 is electrically connected to a gyro sensor 58, the position detection sensor 18, a light emitting diode (LED) lamp 59, the ink cartridge 40, the print button 5a, the power button 5b, the battery 15, and the like. The gyro sensor 58 detects a tilt and a rotation angle of the handheld printer 1 and transmits the result of detection to the control board 14. The LED lamp 59 is disposed inside an exterior cover made of a light transmissive material of the print button 5a and makes the print button 5a luminous.

When the power button 5b is pressed to turn on the power of the handheld printer 1, power is supplied to each module. The CPU 55 initiates startup according to the program stored in the ROM 54 and loads the program and each data in the RAM 53. When data of an image to be formed is received from an external device by short-range wireless communication, the recording controller 56 generates a drive waveform corresponding to the image data. The discharge of ink from the ink cartridge 40 is controlled to form an image corresponding to the position on the surface of the recording medium P detected by the position detection sensor 18.

The position detection sensor 18 detects the direction and the speed of movement of the handheld printer 1 and the distance by which the handheld printer 1 has traveled. The discharge amount of ink and the discharge position of ink are adjusted based on the detection result of the position detection sensor 18, thereby printing a target image. Further, the discharge start position can be adjusted using a sub-scanning guide 7 provided on the left face 32 of the housing 80 and a main scanning guide 10 provided on the rear face 34 of the housing 80. Specifically, the main scanning guide 10 is used to align the position of the handheld printer 1 on the recording sheet P in the main scanning direction (X axis direction in the figure), and the sub-scanning guide 7 is used to align the position of the handheld printer 1 on the recording sheet P in the sub-scanning direction (Y axis direction). Thus, the discharge start position can be adjusted.

In response to acquisition of image data via short-range wireless communication from an external device, the control board 14 causes the LED lamp 59 to blink so that the light transmissive print button 5a, which transmits light, becomes luminous and blinks. Seeing such light blinking, the user knows the completion of the acquisition of the image data. Then, the user places the handheld printer 1 on the recording medium P and presses the print button 5a.

Meanwhile, as the control board 14 starts blinking of the LED lamp 59, the control board 14 waits for pressing of the print button 5a. When the print button 5a is pressed, the control board 14 causes the LED lamp 59 to keep emitting light so that the print button 5a continuously emit light. Seeing the continuous light emission, the user starts moving the handheld printer 1 (manual scanning) in the scanning direction.

The user who has finished moving the handheld printer 1 (manual scanning) again presses the print button 5a. With such an operation, the control board 14 turns off the LED lamp 59 and stops lighting of the print button 5a. Or, there may be a case where the user does not press the print button 5a but picks up the handheld printer 1 from the recording medium P and places the handheld printer 1 on, for example, a table or mounts the handheld printer 1 in a cover 8 of the recording face 30. In these cases, the position detection sensor 18 becomes incapable of detecting the position when the handheld printer 1 is picked up from the recording medium P. At the timing when the position detection sensor 18 no longer detects the position, the control board 14 turns off the LED lamp 59 and stops lighting of the print button 5a. Seeing the stop of lighting, the user knows that the operation of the handheld printer 1 for printing has ended.

It is not necessary to keep pushing the print button 5a while the user moves the handheld printer 1 (manual scanning). When the print button 5a is pressed and released prior to the moving of the handheld printer 1, printing operation is continued until a predetermined timing. Examples of the predetermined timing includes a timing when the image formation based on the detection result by the position detection sensor 18 ends, the timing when the print button 5a is pressed again, and the timing when the position detection sensor 18 becomes incapable of position detection.

A mobile image forming apparatus such as the handheld printer 1 can freely form an image while being moved on the recording medium such as the recording medium P in a freehand manner. Thus, both the convenience of free moving of the apparatus and usability for various types of recording media are achieved.

As illustrated in FIG. 7, the handheld printer 1 according to the present embodiment is provided with the sub-scanning guide 7 on the upstream side (the left face 32 when scanning is performed from the left to the right as illustrated in FIG. 7) in the printing direction. With this configuration, the user can perform printing while simultaneously checking the printed portion W1, constructed of an already printed character string or image, and the sub-scanning guide 7 that is a print position indicator during the printing operation on the recording medium P.

Based on the result of checking, the user can adjust the position of the handheld printer 1 so that the character string to be printed from now comes to the planned print area W2 which is a desired position for printing. Thus, printing can be performed at a desired position on the recording medium P.

The handheld printer 1 detects, with the position detection sensor 18, the amounts of movement in the X axis direction and the Y axis direction on the recording medium P, thereby detecting the position of the handheld printer 1 on the recording medium P. Therefore, when the recording device 41 is located at a given position, the recording device 41 can print a desired character string or a desired image.

There are mobile image forming apparatuses, such as the handheld printer 1, that include a rotator such as the roller assemblies 60 to assist a recording device (such as an ink discharge head) to scan straight toward a desired position on a recording medium. If the rotator tilts with respect to the recording device, the recording device is not positioned at the desired printing position, which results in tilt of characters and images. For this reason, a high accuracy is required in dimensions and positions of components relating to the positional relationship between the rotator and the recording device, and desirably, the rotator holder and the recording device holder are integral with each other as one component.

However, in a mobile image forming apparatus provided with a rotator, if the rotator holder is worn out by repeated use, the inclination of the recording side of the apparatus relative to the surface of the recording medium may increase, or there is a risk that the degree of skewing may increase. In order to prevent a defect due to the wear, the rotator holder may be replaced when the rotator holder wears. However, in the case where the rotator holder and the recording device holder are integral with each other as one component, replacement of the combined component as a whole is required. Thus, replaceability is degraded. In addition, since such component also holds the recording device, a material having a high rigidity is used. Therefore, the sliding performance of the portion in contact with the rotator is poor. Since the sliding friction is high, there are risks of decreases in the durability and the occurrence of noise.

On the other hand, the handheld printer 1 according to the present embodiment is provided with a tilt restriction portion and a normal direction pressed portion as a holder to hold the rotator, and the tilt restriction portion and the normal direction pressed portion are separate component from each other. This configuration can reduce the tilt of the character string and the image to be printed and improve the durability of the mobile image forming apparatus.

Here, descriptions are given below of a rotator including a roller that guides the movement of the handheld printer 1 in the scanning direction and assists the linear movement in the scanning direction.

The two roller assemblies 60 each including the rear side roller 602, the front side roller 603, and the roller shaft 601 have the same configuration.

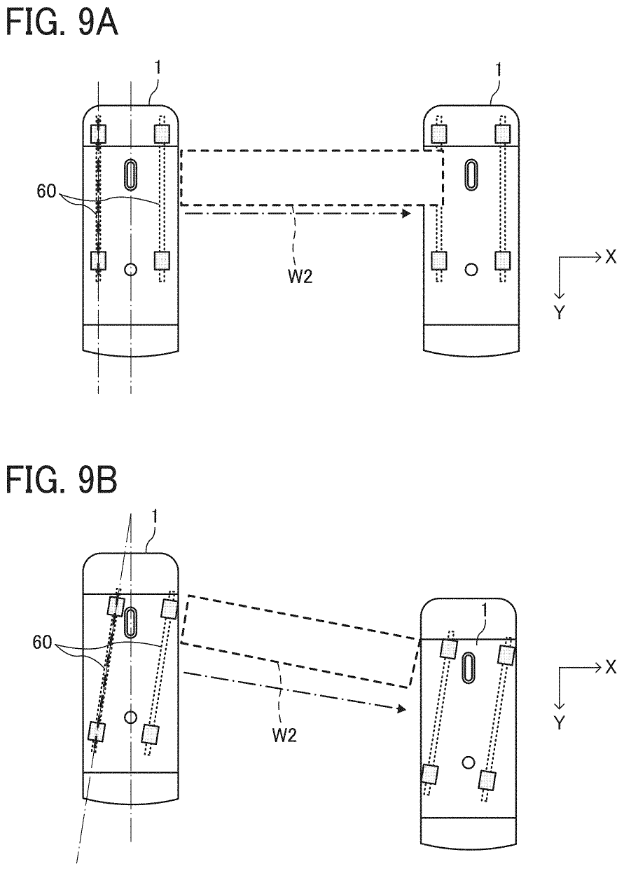

FIGS. 9A and 9B are top views illustrating the relationship between the mounting state of the roller assembly 60 in the handheld printer 1 and the direction of movement of the handheld printer 1. FIG. 9A is an explanatory view of a state in which the roller assemblies 60 are parallel to the recording device 41 (parallel to the direction in which the plurality of discharge nozzles 41a are lined) on the recording face 30. FIG. 9B is an explanatory view of a state in which the roller assemblies 60 are tilted relative to the recording device 41 on the recording face 30. Although FIGS. 9A and 9B are top views, the roller assemblies 60 located on the bottom (the recording face 30) of the handheld printer 1 are illustrated with solid lines for convenience.

The housing 80, which is a recording device holder to support the recording device 41, holds the roller assemblies 60. Then, as illustrated in FIG. 9A, when the axes of the roller assemblies 60 are disposed parallel to the recording device 41, assisted by the rollers of the roller assemblies 60, the user can easily move the handheld printer 1 so that the recording device 41 pass through the planned print area W2.

On the other hand, as illustrated in FIG. 9B, when the roller assembly 60 is inclined with respect to the recording device 41, the direction guided by the roller assemblies 60 is inclined. Therefore, even if the user tries to move the handheld printer 1 in the short side direction of the handheld printer 1 (the X axis direction), the handheld printer 1 moves in a skewed direction. When the handheld printer 1 moves in the skewed direction, it is difficult to move the handheld printer 1 so that the recording device 41 passes through planned print area W2. Since the recording device 41 is not positioned at the desired planned print area W2, characters and images may be printed in a tilted manner.

Further, as in the case of the structure including the position detection sensor 18 similar to the handheld printer 1 according to the present embodiment, the movement of the handheld printer 1 in the inclined direction can be detected. Accordingly, printing is performed based on the detection result, to prevent the character string and the image from tilting. However, when the characters and images that are printed by one movement are inclined relative to the desired scanning direction, the characters and images printed in such scan movement are partially missing. Therefore, multiple times of scanning is necessary, which significantly reduces the operability for the user.

For this reason, a high accuracy is required in dimensions and positions of components relating to the positional relationship between the holders to hold the roller assemblies 60 and the holder to hold the recording device 41, and desirably, the holders of the roller assemblies 60 and the holder of the recording device 41 are integral with each other as one component, and for example, molded in one piece.

However, in such a structure, when the holder portion that holds the roller assembly 60 wears due to repeated use of the handheld printer 1, whole the combined holder should be replaced. Thus, the size of the replaced component increases.

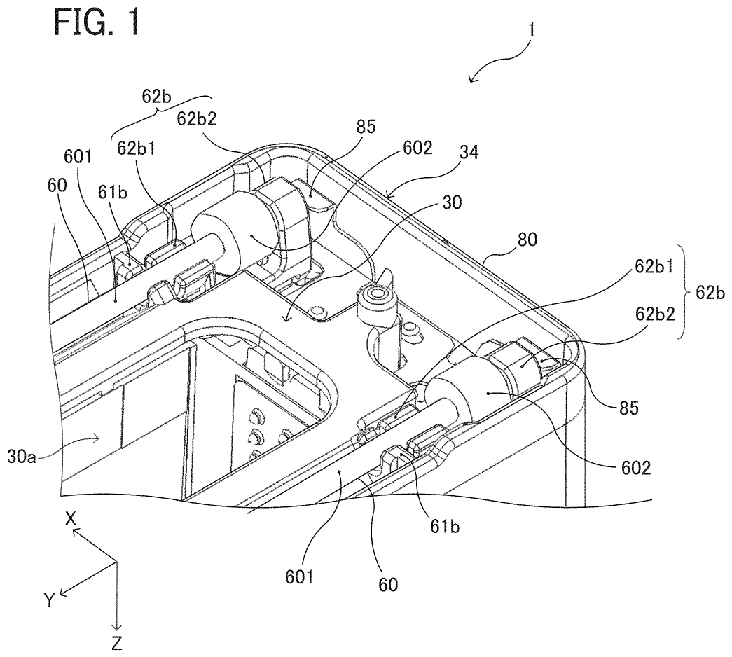

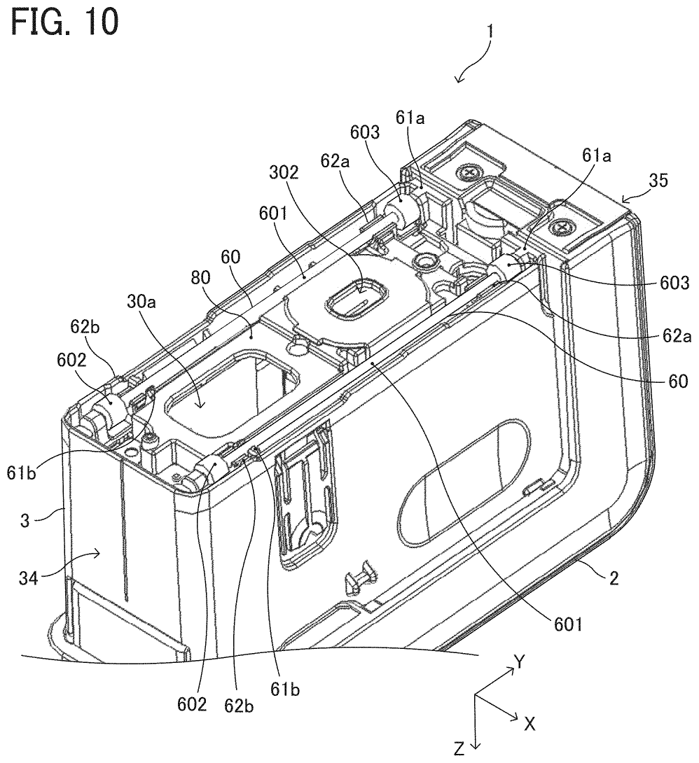

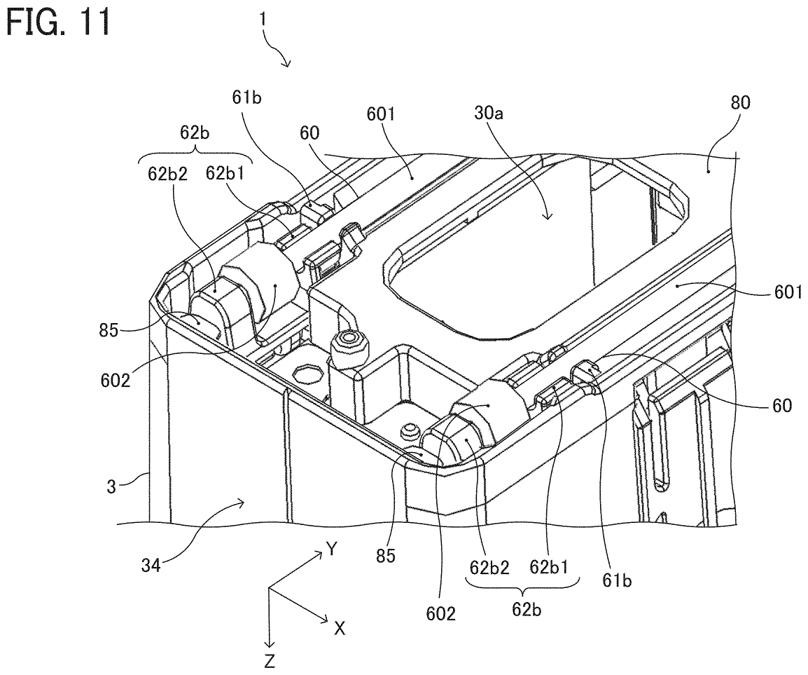

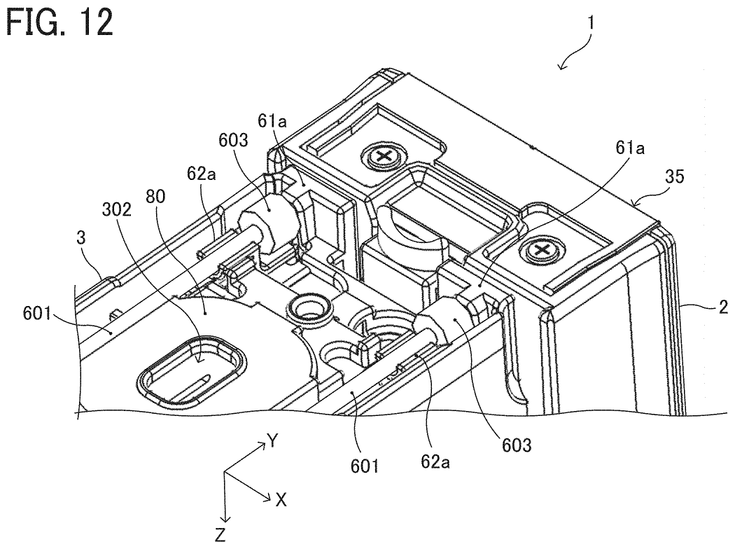

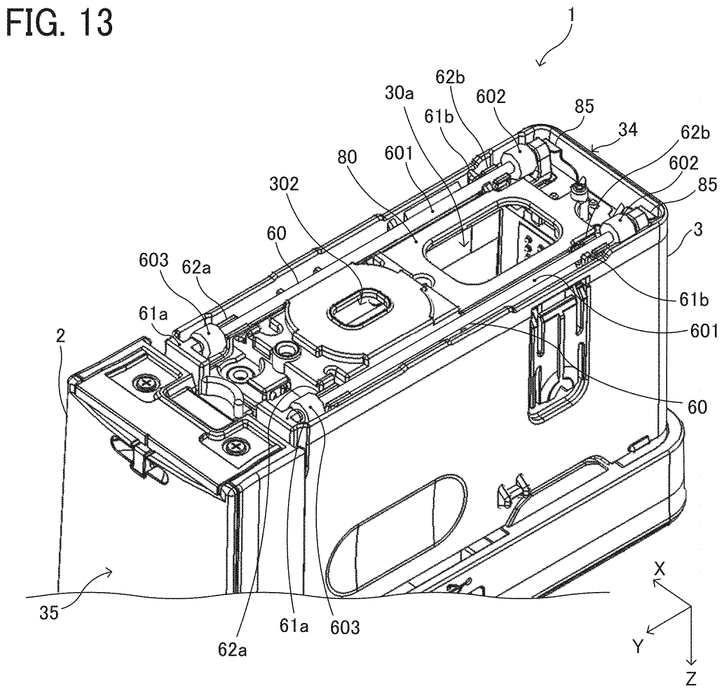

FIG. 10 is an exterior perspective view of the handheld printer 1 as viewed from the lower right on the rear side. FIG. 11 is an enlarged view of an end portion on the rear face 34 side of the handheld printer 1 illustrated in FIG. 10. FIG. 12 is an enlarged view of an end portion on the front face 35 side of the handheld printer 1 illustrated in FIG. 10. FIG. 13 is an exterior perspective view of the handheld printer 1 as viewed from the lower left of the front side. FIG. 14 is an enlarged view of the end portion on the front face 35 side of the handheld printer 1 illustrated in FIG. 13. FIG. 1 is an enlarged view of the end portion on the rear face 34 side of the handheld printer 1 illustrated in FIG. 13.

As illustrated in FIG. 1 and FIGS. 10 to 14, the handheld printer 1 according to the present embodiment includes first roller holders 61 (front-side first roller holders 61a and rear-side first roller holders 61b) and second roller holders 62 (front-side second roller holders 62a and rear-side second roller holders 62b) to hold the roller shafts 601.

The first roller holders 61 (61a and 61b) are configured to restrict the tilt of the roller shaft 601 on the recording face 30 provided with the recording device 41. Here, the tilt on the recording face 30 is a tilt that occurs when the roller shaft 601 is displaced to rotate around a virtual axis orthogonal to the recording face 30. The first roller holders 61 (61a and 61b) that sandwich and hold the roller shaft 601 from both sides in the X axis direction are disposed at two positions in the Y axis direction. This configuration can restrict the tilt of the roller shaft 601 relative to the X axis direction that is the direction of movement of the handheld printer 1 in image formation.

The second roller holders 62 (62a and 62b) are configured to receive force from the roller assemblies 60 in the normal direction (upward direction) to the recording face 30. The second roller holders 62 (62a and 62b) restrict the movement of the roller shafts 601 in the normal vector direction (the upward direction or to the plus side in the Z axis direction in the drawing) on the surface of the recording medium P at the time of image formation.

In the handheld printer 1 according to the present embodiment, the first roller holders 61 (61a and 61b) are portions of the housing 80, and the second roller holders 62 (62a and 62b) are components different from the housing 80. That is, the first roller holders 61 (61a and 61b) and the second roller holders 62 (62a and 62b) are different components.

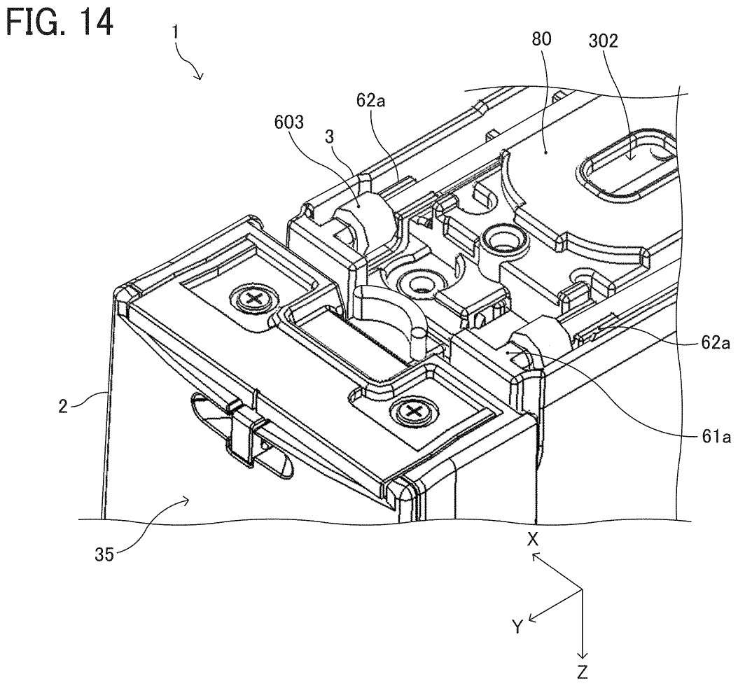

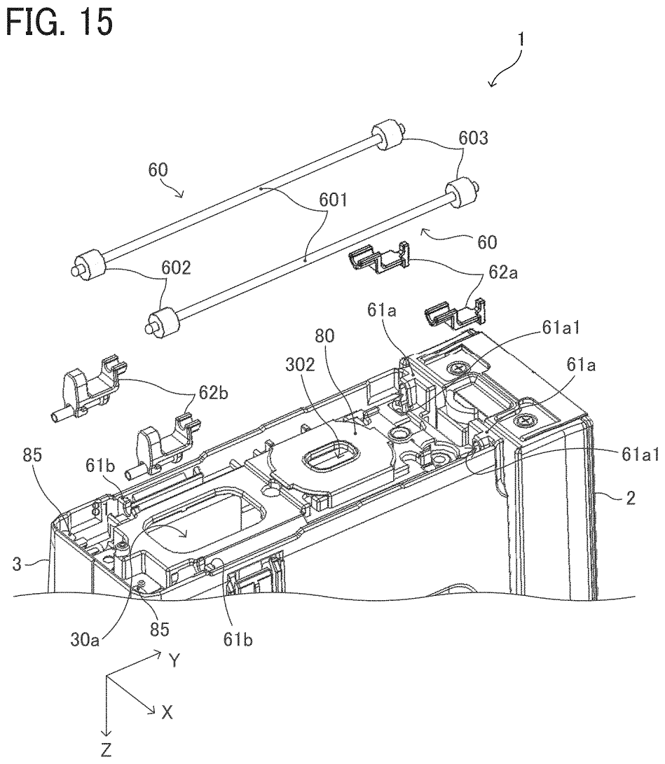

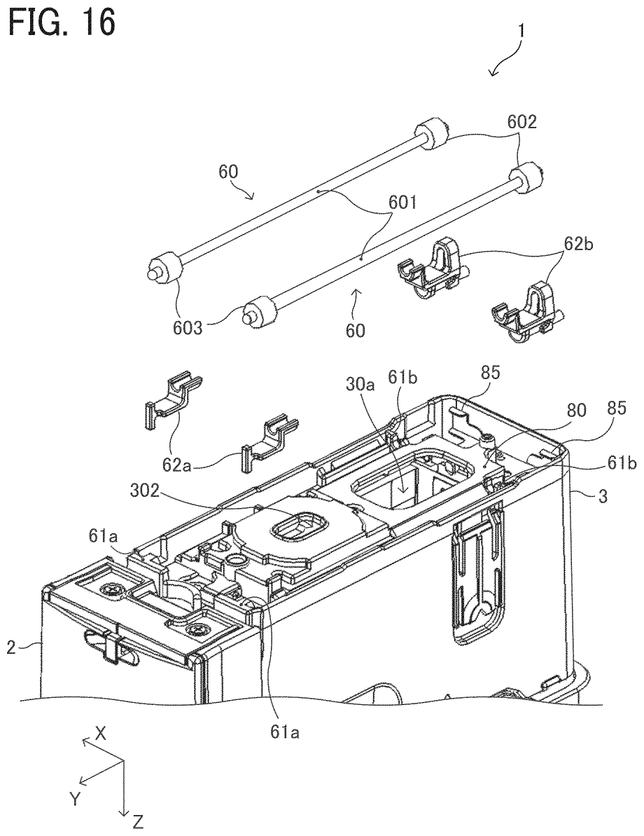

FIG. 15 is an exterior perspective view of the handheld printer 1, together with the roller assemblies 60 and the second roller holders 62 (62a and 62b) in a state removed from the handheld printer 1, as viewed from the rear right side of the bottom. FIG. 16 is an exterior perspective view of the handheld printer 1, together with the roller assemblies 60 and the second roller holders 62 (62a and 62b) in a state removed from the handheld printer 1, as viewed from the front left side of the bottom.

As illustrated in FIGS. 1 and 10 to 16, although collectively called “first roller holders 61” in the specification, the front-side first roller holders 61a disposed on the front face 35 side of the bottom face (the recording face 30) are different in shape from the rear-side first roller holders 61b disposed on the rear face 34 side of the bottom face.

As illustrated in FIG. 15, the front-side first roller holder 61a includes a front-side slot 61al having a long axis along the Z axis direction and a short axis along the X axis direction. As illustrated in FIGS. 12 and 14, the front-side first roller holder 61a holds an end of the roller shaft 601 on the front face 35 side. The length of the short axis of the front-side slot 61a1 is substantially equal to the diameter of the roller shaft 601, and the roller shaft 601 whose end is inserted into the front-side slot 61a1 is inhibited from moving in the X axis direction.

Further, the front-side slot 61a1 is not a through hole but a hole (a recess) having a bottom on the front side (plus side in the Y axis direction). As the end face of the roller shaft 601 on the front face 35 side (plus side in the Y axis direction) contacts the bottom surface of the front-side slot 61al, the roller shaft 601 is inhibited from moving to the front side (plus side in the Y axis direction).

As illustrated in FIGS. 1, 11, 15, and 16, the rear-side first roller holder 61b is U-shaped with an opening on the minus side in the Z axis direction. The rear-side first roller holder 61b holds the roller shaft 601 at a position closer to the plus side end in the Y axis direction (the front face 35 side) than the rear side roller 602. The width of the U-shaped inner wall of the rear-side first roller holder 61b is substantially equal to the diameter of the roller shaft 601, and the roller shaft 601 located inside the U-shape is restricted from moving in the X axis direction.

As described above, the front-side first roller holder 61a and the rear-side first roller holder 61b together restrict, at two points in the Y axis direction, movement of the roller shaft 601 in the X axis direction. With this structure, the tilt of the roller shaft 601 with respect to the X-Y plane can be restricted.

The front-side first roller holder 61a and the rear-side first roller holder 61b are both parts of the housing 80 that supports the recording device 41. Therefore, differently from the configuration in which the first roller holder 61 is a different component from the housing 80 and attached to the housing 80, no assembling error occurs, and the first roller holder 61 can be prevented from tilting with respect to the recording device 41.

As illustrated in FIGS. 1 and 10 to 16, although collectively called “second roller holders 62” in the specification, the front-side second roller holders 62a disposed on the front face 35 side of the bottom face (the recording face 30) are different in shape from the rear-side second roller holders 62b disposed on the rear face 34 side.

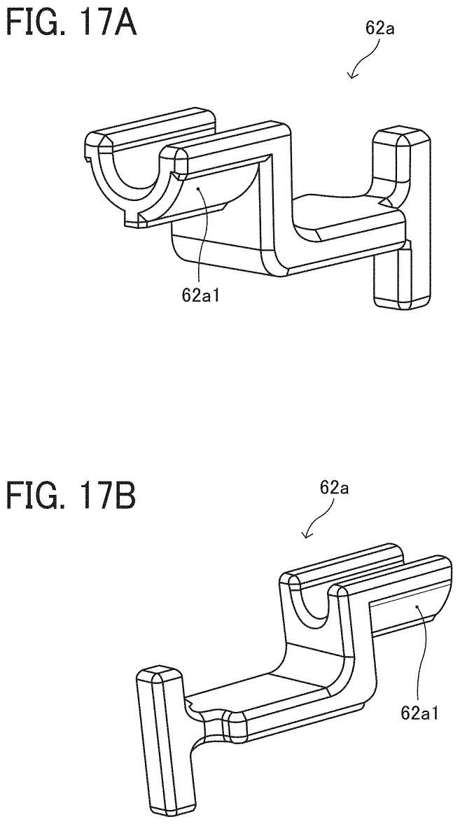

FIGS. 17A and 17B are perspective views of the front-side second roller holder 62a. FIG. 17A is a perspective view illustrating the front-side second roller holder 62a as viewed from the same angle as in FIG. 15. FIG. 17B is a perspective view illustrating the front-side second roller holder 62a as viewed from the same angle as in FIG. 16.

As illustrated in FIG. 17, the front-side second roller holder 62a includes a front-side shaft contact portion 62a1 that is semicylindrical. The front-side shaft contact portion 62a1 is designed so that a top on the circumference of the roller shaft 601 contacts a semicylindrical inner face thereof.

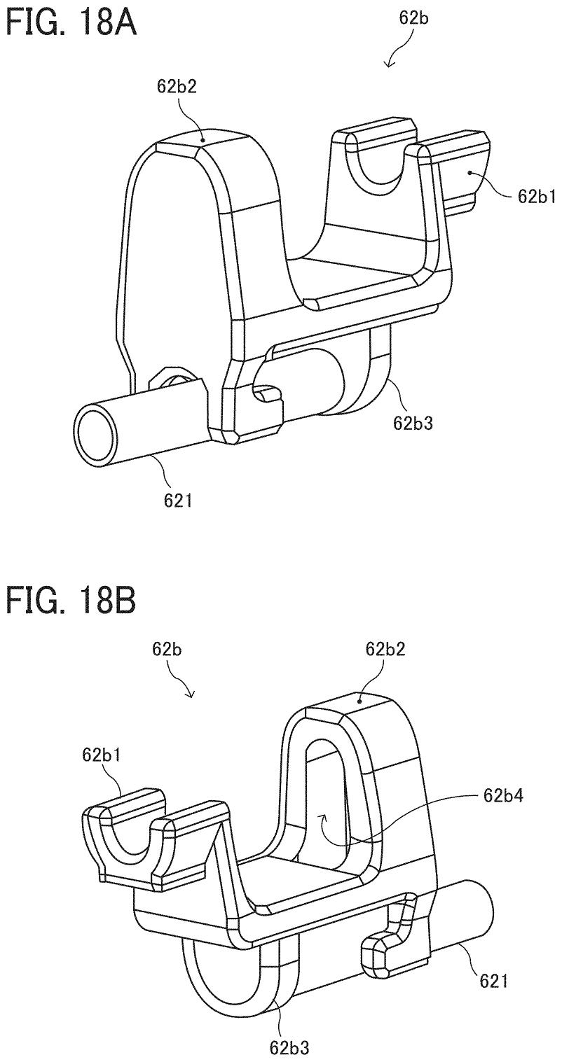

FIGS. 18A and 18B are perspective views of the rear-side second roller holder 62b. FIG. 18A illustrates the rear-side second roller holder 62b as viewed from the same angle as in FIG. 15. FIG. 18B illustrates the rear-side second roller holder 62b as viewed from the same angle as in FIG. 16.

As illustrated in FIGS. 18A and 18B, the rear-side second roller holder 62b includes a rear-side shaft contact portion 62b1 that is semicylindrical so that the top on the circumference of the roller shaft 601 contacts a semicylindrical inner face of the rear-side shaft contact portion 62b1. The rear-side second roller holder 62b further includes a rear-side shaft end contact portion 62b2 having a rear-side slot 62b4. The rear-side second roller holder 62b further includes a spring holder 62b3 to hold a compression spring 621. The rear-side slot 62b4 having a long axis along the Z axis direction and a short axis along the X axis direction. The short axis, that is, the length in the X axis direction, is longer than the diameter of the roller shaft 601, and the rear-side slot 62b4 does not contribute to the positioning of the roller shaft 601.

The rear-side slot 62b4 is not a through hole but a hole (a recess) having a bottom on the rear side (minus side in the Y axis direction). In a state in which the components are assembled together, the end face of the roller shaft 601 on the rear face 34 side (the minus side in the Y axis direction) contacts or abuts against the bottom of the rear-side slot 62b4 of the rear-side second roller holder 62b, which is urged to the front face 35 side by the compression spring 621. Thereby, the movement of the roller shaft 601 to the rear face 34 side (minus side in the Y axis direction) can be restricted.

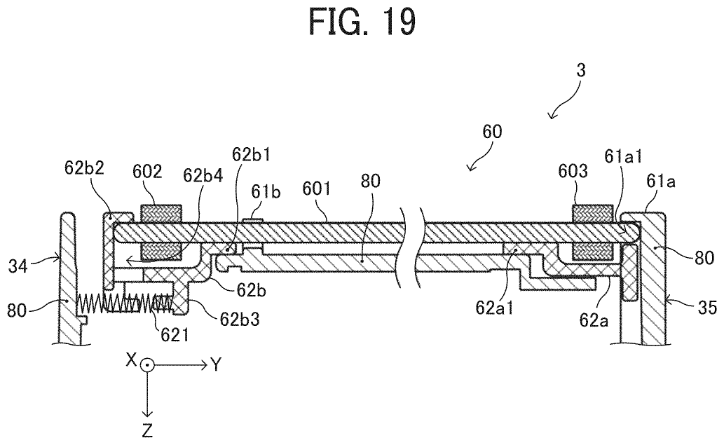

FIG. 19 is a cross-sectional view illustrating attaching of the roller assembly 60 to the housing 80. At the time when the roller assembly 60 is attached to the housing 80, the front-side second roller holder 62a is secured to the housing 80. The rear-side second roller holder 62b is held movable only in the Y axis direction (the lateral direction in FIG. 19) with respect to the housing 80, and the compression spring 621 urges the rear-side second roller holder 62b toward the front face 35 side, thereby positioning the compression spring 621.

When the roller assembly 60 is attached to the housing 80, the roller shaft 601 is disposed at an angle with respect to the lower face of the housing 80, and the end of the roller assembly 60 on the rear face 34 side (left side in FIG. 19) is inserted into the rear-side slot 62b4 of the rear-side second roller holder 62b. In the inserted state, the roller shaft 601 is pushed to the rear face 34 side (left side in FIG. 19), thereby compressing the compression spring 621, so that the rear-side second roller holder 62b slides to the rear face 34 side (left side in FIG. 19).

Next, the roller shaft 601 is disposed parallel to the lower face of the housing 80, and the roller shaft 601 is slid to the front face 35 side (right side in FIG. 19). Then, the end of the front face 35 side (right side in FIG. 19) of the roller shaft 601 is inserted into the front-side slot 61a1 of the front-side first roller holder 61a so that the end face of the roller shaft 601 contacts the bottom of the front-side slot 61a1.

As the roller shaft 601 is slid to the front face 35 side (right side in FIG. 19), the rear-side second roller holder 62b is also slid to the front face 35 side (right side in FIG. 19) by the biasing force of the compression spring 621. Then, the roller assembly 60 is in the state illustrated in FIG. 19.

In the state illustrated in FIG. 19, the position of the roller assembly 60 in the X axis direction is determined by the front-side first roller holder 61a and the rear-side first roller holder 61b. The position of the roller assembly 60 in the Y axis direction is determined by the bottom of the front-side slot 61al of the front-side first roller holder 61a and the bottom of the rear-side slot 62b4 of the rear-side second roller holder 62b.

The roller assembly 60 is inhibited from moving toward the upper face 31 side (lower side in FIG. 19) in the Z axis direction as the roller shaft 601 contacts the front-side shaft contact portion 62a1 and the rear-side shaft contact portion 62b1. Further, the roller assembly 60 is inhibited from moving toward the lower side of the apparatus (upper side in FIG. 19) in the Z axis direction as the roller shaft 601 is caught on the respective edges of the front-side slot 61a1 and the rear-side slot 62b4 on the lower side of the apparatus (upper side in FIG. 19). The configuration in which the roller shaft 601 is caught by the edges of the front-side slot 61a1 and the rear-side slot 62b4 on the lower side of the apparatus can prevent the roller assembly 60 from dropping off when the handheld printer 1 is not used, such as when the handheld printer 1 is lifted from the recording medium P.

In the state illustrated in FIG. 19, when force that slides the roller assembly 60 toward the rear face 34 side (left side in FIG. 19) acts on the lower unit 3, the compression spring 621 is compressed, and there arises a possibility that the roller assembly 60 is shifted toward the rear face 34 side relative to the lower unit 3. In addition, when the position of the roller assembly 60 is shifted to the rear face 34 side, the end on the front face 35 side of the roller shaft 601 may come out of the front-side slot 61al, and the roller assembly 60 may be disengaged from the lower unit 3.

By contrast, the handheld printer 1 according to the present embodiment further includes a flat spring 85 (see FIGS. 1 and 11) that abuts against a face on the rear face 34 side of the rear-side shaft end contact portion 62b2 and urges the rear-side shaft end contact portion 62b2 toward the front face 35 side. After the roller assembly 60 is attached to the housing 80, the flat spring 85 is secured to the housing 80. This structure can prevent the roller assembly 60 from moving toward the rear face 34 side with respect to the lower unit 3, after the roller assembly 60 is attached to the housing 80.

To form an image on a recording medium P such as a paper sheet using handheld printer 1, the handheld printer 1 is moved for scanning along the surface of the recording medium while being pressed against the recording medium by the weight of the handheld printer 1 or the pressing force of the user. At this time, in the forces exerted from the roller assembly 60 on the component that holds the roller assembly 60, a reaction force against the force that presses the handheld printer 1 against the recording medium is greater than a reaction force against the force that moves the handheld printer 1 along the surface of the recording medium. Therefore, in the components that hold the roller assembly 60, the load increases against the portion that restricts the movement of the roller assembly 60 in the direction normal to the surface of the recording medium. Accordingly, there is a risk that the sliding load when the roller assembly 60 rotates becomes large.

In the handheld printer 1 according to the present embodiment, the first roller holders 61 (61a and 61b) and the second roller holders 62 (62a and 62b) are provided in the housing 80 that supports the recording device 41. The first roller holders 61 (61a and 61b) are configured to restrict the tilt of the roller assembly 60 in the scanning direction in which the handheld printer 1 is moved for printing. The second roller holders 62 (62a and 62b) are configured to restrict the movement of the roller assembly 60 in the direction opposing the recording medium.

In the handheld printer 1 according to the present embodiment, the first roller holders 61 are separate components from the second roller holders 62. That is, the portion where the load from the roller assembly 60 is large and accordingly the sliding load may be large is separated from the portion that restricts the tilt of the roller assembly 60 with respect to the direction of movement for image formation. This structure is advantageous in that the durability of the apparatus and the function of restricting the tilt of the roller assembly 60 can be handled by separate components, and both the prevention of the skew of the handheld printer 1 and the improvement of the durability of the handheld printer 1 can be attained easily.

In the handheld printer 1 according to the present embodiment, in order to restrict the tilt of the roller assembly 60 and inhibit skew, the housing 80 to support the recording device 41 is provided with the first roller holders 61. A higher degree of rigidity is required for the material of the housing 80, and it is difficult to increase the slidability with the same material.

Therefore, if the second roller holders 62 and the housing 80 are portions of the same component, when priority is given to the rigidity of the housing 80, the slidability of the portions serving as the second roller holders 62 in the housing 80 is degraded, and the durability is degraded. By contrast, when priority is given to the slidability of the portions serving as the second roller holders 62 in the housing 80, the rigidity of the entire housing 80 may be insufficient, and the housing 80 may be deformed.

By contrast, in the structure in which the housing 80 having the first roller holders 61 is a separate component from the second roller holders 62, both the prevention of the skew of the handheld printer 1 and the improvement of the durability of the handheld printer 1 can be attained easily.

To improve the durability of the handheld printer 1, for example, a lubricant such as grease can be applied to a portion of the first roller holder 61 which can contact the roller shaft 601, to suppress wear of the first roller holder 61.

Further, the material of the second roller holder 62 has higher slidability than the slidability of the material of the housing 80 in which the first roller holder 61 is formed. Durability can be improved by reducing the sliding friction of the component in which the load from the roller assembly 60 increases when the handheld printer 1 is moved for scanning.

Constructing the second roller holders 62 of a component having higher slidability is advantageous in reducing the frictional resistance when the roller assembly 60 rotates. Accordingly, this configuration can suppress the wear of the roller shaft 601 and the second roller holders 62 and noise when the roller assembly 60 rotates. This configuration can further inhibit the roller assembly 60 from slipping on the recording medium P due to the large sliding load when the roller assembly 60 rotates and can inhibit skew of the handheld printer 1 when scanning in the print direction (X axis direction) is attempted.

As a material of the housing 80 having the first roller holder 61, a mixture of polycarbonate (PC) and acrylonitrile butadiene styrene (ABS) can be used. As a material of the second roller holders 62, polyacetal can be used.

The material of the first roller holders 61 and the material of the second roller holders 62 are not limited to thereto.

The material of the housing 80 having the first roller holders 61 is preferably a flame retardant material because the housing 80 forms the exterior of the lower unit 3.

Since the second roller holder 62 is sufficiently small as compared with the housing 80, it is less necessary to consider flame retardancy of the second roller holder 62 compared with the housing 80, and, desirably, the slidability of the material of the second roller holders 62 is as high as possible.

Further, when the first roller holders 61 is integral with the housing 80 that supports the recording device 41, the roller assembly 60 is prevented from tilting with respect to the recording device 41 in the X-Y plane, thereby preventing the handheld printer 1 from skewing in image formation. For this reason, the occurrence of tilt of printed characters and images can be inhibited, thereby improving the image quality.

Since the housing 80 includes the first roller holders 61, the tilt of the recording device 41 with respect to the scanning direction (X axis direction) is reduced, and printing can be performed straight.

In the handheld printer 1 according to the present embodiment, the ink cartridge 40 having the recording device 41 is not directly held by the housing 80, and the ink cartridge 40 is held by a basket-like member secured inside the housing 80. Although one component (the basket-like member) is sandwiched between the housing 80 and the recording device 41, accumulation of assembling error is suppressed because the first roller holders 61 are portions of the housing 80. Accordingly, the roller assembly 60 can be prevented from tilting with respect to the recording device 41.

In the handheld printer 1 according to the present embodiment, the second roller holders 62 are attachable to and removable from the housing 80. As a result, when the second roller holders 62 wears out due to the friction between the roller assembly 60 and the roller shaft 601, the second roller holders 62 can be easily replaced, thereby improving the maintainability.

In the handheld printer 1 according to the present embodiment, the housing 80, which is the recording device holder that supports the ink cartridge 40 including the recording device 41, includes the first roller holders 61 that restrict the tilt of the roller assembly 60 relative to the scanning direction (X axis direction). The handheld printer 1 according to the present embodiment further includes the second roller holders 62 that regulate the position of the roller assembly 60 in the direction opposed to (perpendicular to) the recording medium P (prevents the roller assembly 60 from moving upward with respect to the body of the handheld printer 1). The second roller holders 62 are different components (separate component) from the housing 80 provided with the first roller holders 61, and the second roller holders 62 are made of a material having higher slidability. Accordingly, the tilt of the character string and the image to be printed can be further reduced, and the durability of the handheld printer 1 can be improved.

Although the present embodiment concerns the handheld printer 1 that is held and moved by the user for performing printing, alternatively, aspects of the present disclosure can adapt to an image forming apparatus provided with a driver such as a motor and a drive transmission device to input a drive force to the roller assemblies 60. With such a configuration, the handheld printer 1 can automatically move for scanning, and printing can be performed without an operation of the user.

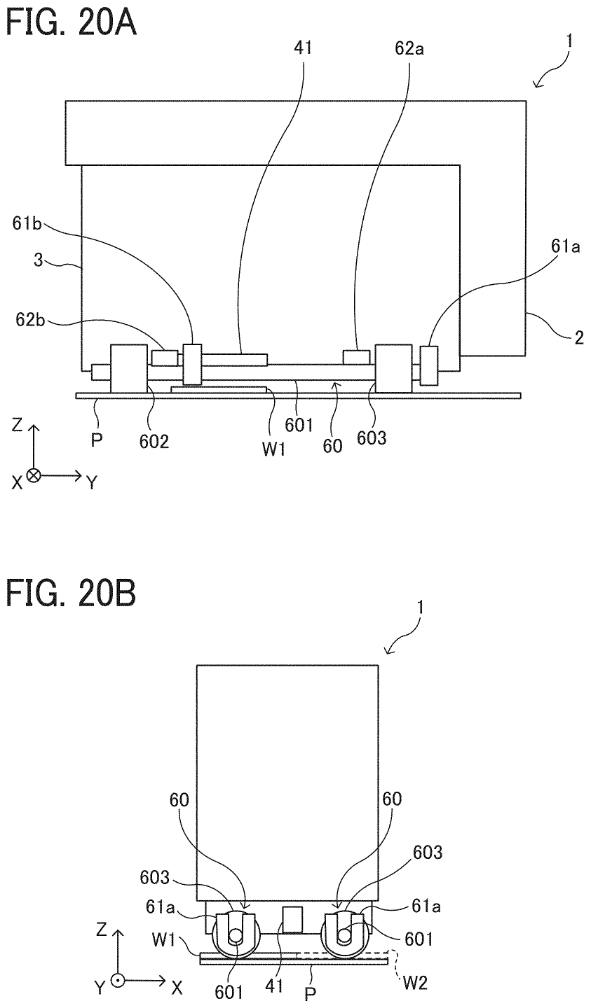

FIGS. 20A and 20B are schematic views illustrating the positional relationship between the printed portion W1 on the recording medium P and the rollers (the rear side rollers 602 and the front side rollers 603) of the roller assemblies 60. FIG. 20A is a side view illustrating the handheld printer 1 as viewed from the left face 32 side, and FIG. 20B is a side view of the handheld printer 1 as viewed from the front face 35 side.

As illustrated in FIGS. 20A and 20B, each of the roller assemblies 60 includes the rear side roller 602 and the front side roller 603 as recording medium contact portions that contact the recording sheet P. In the axial direction of the roller assembly 60 (the Y axis direction in FIGS. 20A and 20B), the positions of the rear side roller 602 and the front side roller 603 are different from the position of the recording device 41. Such an arrangement can prevent the rear side roller 602 and the front side roller 603 from coming into contact with the printed portion W1 in which characters and images are printed. Accordingly, the characters and images in the printed portion W1 are protected from being rubbed, and smear of the recording medium P is prevented. Thus, the image quality can be improved.

To prevent smear of the characters and the image in the printed portion W1 and stains on the recording medium P caused by the contact of the rear side roller 602 and the front side roller 603, alternatively, coatings can be provided on the surfaces of the rear side roller 602 and the front side roller 603.

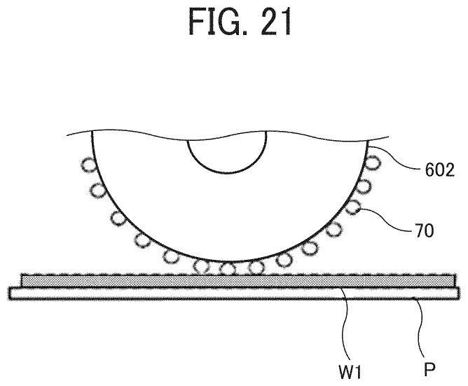

FIG. 21 is a schematic view illustrating the rear side roller 602 provided with a coating 70. Providing the coating 70 is advantageous in that adhesion of the ink to the rear side roller 602 can be prevented even if the rear side roller 602 which contacts the printed portion W1 in which characters and images are printed. Accordingly, smear of the character or image in the printed portion W1 and stains on the recording medium P can be prevented. Providing the coating 70 can prevent smear of the character or image in the printed portion W1 and stains on the recording medium P even if the positions of the rear side roller 602 and the front side roller 603 are not different from the position of the recording device 41 in the axial direction of the roller assembly 60 (the Y axis direction in FIGS. 20A and 20B).

Examples of the coating 70 include a coating of ceramic or glass particles, as illustrated in FIG. 21, or a water repellent coating such as a fluorine coating.

Although descriptions have been made above of the examples in which aspects of the present disclosure are applied to the inkjet handheld printer 1, the aspects of the present disclosure can also be applied to other types of image forming apparatuses. The aspects of the present disclosure can be applied to a recording apparatus of, for example, thermal type or thermal-transfer type.

The structures described above are examples, and aspects of the present disclosure provide respective effects as follows.

### Aspect 1

Aspect 1 concerns a mobile image forming apparatus, such as the handheld printer 1, that includes a recording device, such as the recording device 41, that records an image on a recording medium, such as the recording medium P (a paper sheet); a rotator, such as the roller assembly 60, that contacts the recording medium and rotatable thereon; and rotator holders, such as the first roller holders 61 and the second roller holders 62, to hold the rotator. The rotator holders include a tilt restriction portion, such as the first roller holders 61, configured to restrict a tilt of a rotation shaft, such as the roller shaft 601, of the rotator. Specifically, the tilt restriction portion restricts a tilt of the rotation shaft on the recording face, such as the recording face 30, on which the recording device is disposed. The rotator holders further include a normal direction pressed portion, such as the second roller holders 62, configured to receive force in a direction normal to the recording face (upward direction etc.), exerted from the rotator, and the normal direction pressed portion is a different component from the tilt restriction portion.

According to this aspect, in image formation by the mobile image forming apparatus, linear guidance can be realized at a reduced cost owing to the following factors.

To form an image on a recording medium using the mobile image forming apparatus, the apparatus is moved for scanning along the surface of the recording medium while being pressed against the recording medium by the weight of the apparatus or the pressing force of the user. At this time, force for pressing the mobile image forming apparatus against the recording medium and force for moving the mobile image forming apparatus along the surface of the recording medium act on the rotator. Further, reaction forces against these forces act on the rotator holders that holds the rotator in the mobile image forming apparatus. At this time, in the forces exerted from the rotator on the rotator holder, the reaction force against the force that presses the apparatus against the recording medium is greater than the reaction force against the force that moves the apparatus along the surface of the recording medium. That is, the force acting from the rotator on the normal direction pressed portion, which receives the force from the rotation shaft in the direction normal to the recording face, is larger than the force acting from the rotator on the tilt restriction portion, which restricts the tilt of the rotation shaft. The sliding load tends to be greater in the normal direction pressed portion on which the force acts from the rotator than in the tilt restriction portion, and deformation due to wear is apt to occur. Therefore, in order to prevent the displacement of the rotator due to the sliding contact (rubbing), it is necessary that the normal direction pressed portion is made of a material having higher wear resistance and higher slidability and that replacement of the normal direction pressed portion is easy. By contrast, in order to prevent skewing of the mobile image forming apparatus with respect to a desired moving direction, a higher degree of accuracy is required in relative positions between the tilt restriction portion and the recording device holder, such as the housing 80, that supports the recording device so that the rotation shaft does not tilt on the recording face. In a case where the tilt restriction portion and the normal direction pressed portion are integral with each other as one component, the component that is made of the highly slidable material and easily replaceable is to be accurately positioned with respect to the recording device holder. Realization of such a structure requires a high cost. By contrast, in Aspect 1, the tilt restriction portion and the normal direction pressed portion are different members. Accordingly, features that highly slidable material is used and the replacement is easy to prevent the displacement of the rotator due to the sliding contact are realized with one of the different members, and another feature that the tilt restriction portion is positioned with a high accuracy relative to the recording device holder, thereby preventing skew, can be realized with the other member. This configuration can reduce the cost of the configuration to accurately position the rotator with respect to the recording device holder to prevent the skewing. Further, linear guidance in image formation using the mobile image forming apparatus can be realized at a reduced cost.

### Aspect 2

In Aspect 1, the normal direction pressed portion is higher in slidability than the tilt restriction portion.

Use of a component having a higher degree of slidability as the normal direction pressed portion can suppress wear due to the sliding contact and accordingly inhibit deformation of the rotator holder by the wear. Thus, durability can be improved.

### Aspect 3

In Aspect 1 or 2, the recording device holder such as the housing 80 to hold the recording device and the tilt restriction portion are integral with each other as one component.

According to this aspect, the tilt restriction portion can be positioned with a high accuracy with respect to the recording device holder, thereby improving the accuracy of the linear guiding direction in image formation using the mobile image forming apparatus.

Accordingly, the tilt of a character string and an image to be formed can be reduced.

### Aspect 4

In any one of Aspects 1 to 3, the normal direction pressed portion is configured to be removable from the apparatus body.

According to this aspect, since the normal direction pressed portion in which the force acting from the rotator is large and the sliding load tends to be large is removable, replacement of the component is feasible when the component wears by the sliding contact, and maintainability can be improved.

### Aspect 5

In any one of Aspects 1 to 4, the rotator includes a recording medium contact portion, such as the rear side rollers 602 and the front side rollers 603, that contacts the recording medium, and a position of the recording medium contact portion is different from a position of the recording device in the axial direction of the rotation shaft.

According to this aspect, the recording medium contact portion of the rotator can be prevented from contacting the characters or the image formed on the recording medium. For this reason, this configuration can prevent the occurrence of blurring of characters and images and adhesion of the image forming substance (e.g., ink) forming the characters and the image to the recording medium contact portion and transfer of such ink adhesion to other portions on the recording medium, resulting in stains on the recording medium.

### Aspect 6

In any one of Aspects 1 to 5, the rotator includes a recording medium contact portion, such as the rear side rollers 602 and the front side rollers 603, that contacts the recording medium, and the recording medium contact portion is provided with surface treatment such as formation of the coating 70.

According to this aspect, the recording medium contact portion of the rotator can be inhibited from being soiled with the image forming substance (e.g., ink) forming the characters or the image on the recording medium. For this reason, this configuration can prevent the occurrence of blurring of characters and images and adhesion of the image forming substance (e.g., ink) forming the characters and the image to the recording medium contact portion and transfer of such adhesion to other portions of the recording medium, resulting in stains on the recording medium.

### Aspect 7

Aspect 7 concerns a body, such as the housing 80, of a mobile image forming apparatus, such as the handheld printer 1. The body includes a rotator, such as the roller assembly 60, that contacts a recording medium, such as the recording medium P (a paper sheet), and rotatable thereon; and rotator holders, such as the first roller holders 61 and the second roller holders 62, to hold the rotator. Further, a recording device, such as the recording device 41, that records an image on the recording medium is removably attached to the body. The rotator holders include a tilt restriction portion, such as the first roller holders 61, configured to restrict a tilt of a rotation shaft, such as the roller shaft 601, of the rotator. Specifically, the tilt restriction portion restricts a tilt of the rotation shaft on the recording face, such as the recording face 30, on which the recording device is disposed. The rotator holders further include a normal direction pressed portion, such as the second roller holders 62, configured to receive force in a direction normal to the recording face (upward direction etc.), exerted from the rotator, and the normal direction pressed portion is a different component from the tilt restriction portion.

According to this aspect, similar to Aspect 1 described above, in image formation by the mobile image forming apparatus, linear guidance can be realized at a reduced cost.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. An image forming apparatus comprising:
a body including a recording face to be disposed opposite a recording medium;
a recording device supported by the body and configured to record an image on the recording medium;
a rotator including a rotation shaft and configured to contact the recording medium and rotate on the recording medium; and
a rotator holder configured to hold the rotator, the rotator holder including:
a tilt restriction portion configured to restrict a tilt of the rotation shaft of the rotator, the tilt being a rotation around a virtual axis orthogonal to the recording face; and
a normal direction pressed portion configured to receive force in a direction normal to the recording face, exerted from the rotator, the normal direction pressed portion being a different component from the tilt restriction portion.

2. The image forming apparatus according to claim 1,
wherein the normal direction pressed portion is higher in slidability than the tilt restriction portion.

3. The image forming apparatus according to claim 1, further comprising a recording device holder configured to hold the recording device, the recording device holder integral with the tilt restriction portion.

4. The image forming apparatus according to claim 1,
wherein the normal direction pressed portion is configured to be removable from the body.

5. The image forming apparatus according to claim 1,
wherein the rotator includes a recording medium contact portion configured to contact the recording medium, the recording medium contact portion disposed at a position different from a position of the recording device in an axial direction of the rotation shaft.

6. The image forming apparatus according to claim 1,
wherein the rotator includes a recording medium contact portion configured to contact the recording medium, and
wherein the recording medium contact portion is provided with surface treatment.

7. An image forming apparatus body to which a recording device configured to record an image on a recording medium is removably attached, the body comprising:
a recording face to be disposed opposite the recording medium;
a rotator including a rotation shaft, the rotator configured to contact the recording medium and rotate on the recording medium; and
a rotator holder configured to hold the rotator, the rotator holder including:
a tilt restriction portion configured to restrict a tilt of the rotation shaft of the rotator, the tilt being a rotation around a virtual axis orthogonal to the recording face; and
a normal direction pressed portion configured to receive force in a direction normal to the recording face, exerted from the rotator, the normal direction pressed portion being a different component from the tilt restriction portion.
